(19) United States
(12) Patent Application Publication
(10) Pub. No.: US 2016/0015059 A1
(43) Pub. Date: Jan. 21, 2016

(54) FOOD PRODUCTS CONTAINING COFFEE CHERRY PARTICULATES AND METHODS FOR THEIR PREPARATION

(71) Applicant: EMPIRE TECHNOLOGY DEVELOPMENT LLC, Wilmington, DE (US)

(72) Inventor: Daniel Alderic BELLIVEAU, Bellevue, WA (US)

(73) Assignee: EMPIRE TECHNOLOGY DEVELOPMENT LLC, Wilmington, DE (US)

(21) Appl. No.: 14/774,121

(22) PCT Filed: Dec. 20, 2013
(86) PCT No.: PCT/US13/77293

§ 371 Date: Sep. 9, 2015

Related U.S. Application Data
(60) Provisional application No. 61/785,195, filed on Mar. 14, 2013.

(51) Int. Cl. A23L 1/164; A21D 13/00; A21D 2/36; A21D 13/04; A23L 1/212; A21D 10/00

(52) U.S. Cl. CPC A23L 1/1645; A23L 1/2126; A21D 10/005; A21D 2/36; A21D 13/04; A21D 13/0074; A23V 2002/00

(57) ABSTRACT

Food products having portions of a dried deseeded coffee cherry are described, as well as components thereof and methods of forming. The food product may include one or more portions of a dried deseeded coffee cherry and a corn-derived ingredient.

### CROSS-REFERENCE TO RELATED APPLICATIONS

This application claims the priority benefit of U.S. Provisional Patent Application No. 61/785,195, filed Mar. 14, 2013 and entitled “Flour Compositions and Food and Beverages Comprising Thereof”, which is incorporated herein by reference in its entirety.

### BACKGROUND

The domestic consumption of coffee has increased about 57.6% in coffee exporting countries between 2000 and 2011. In addition, the consumption of coffee in coffee importing countries has increased about 10.8% between 2000 and 2010. In total, world coffee production in 2011 used about 7.9 million tons of coffee beans.

To obtain the coffee beverage that is widely consumed throughout the world, coffee beans must be removed from coffee cherries and processed. There are two types of isolation processes (“coffee processing”) that are commonly used: dry processing and wet processing. Dry processing includes, after harvesting, drying the coffee cherries to a low moisture content. The coffee beans are separated from the material covering the beans (for example, the outer skin, pulp, parchment, and silverskin) using a de-hulling machine. Wet processing, on the other hand, does not require drying of the cherries. In a wet processing method, the outer skin and the pulp are mechanically removed, and the beans are fermented to remove a layer of remaining pulp material thereon. After fermentation, the coffee beans are dried and dehulled to remove the parchment. The bean is the only material retained for sale or storage, with the remainder of the coffee cherries being discarded, used as organic compost, or burned as fuel. Thus, when the remainder is discarded, 50% of the total mass of the coffee cherry is discarded as byproduct material. Thus, to obtain every ton of coffee beans, a ton of byproduct material must be generated. With the ever-increasing consumption of coffee throughout the world, the amount of byproduct has rapidly increased.

In coffee producing countries, the coffee byproducts constitute a source of contamination and environmental concern. For example, the pulp and the mucilage are relatively acidic, corrosive to equipment, and difficult to safely dispose. Furthermore, the pulp and the mucilage can lower the pH of waterways, which could potentially be deleterious to fish and other aquatic life forms. Additionally, where the pulp is discarded in a landfill or other disposal site, rotting pulp will often generate significant odors over time. Accordingly, it may be desirable to reduce waste from coffee byproducts, particularly portions of the coffee cherry that are not used for typical coffee bean purposes, such as, for example, the pulp, the mucilage, the stem, and/or the hull.

Previous methods of reducing coffee cherry waste included processing the coffee byproducts for human consumption. However, these methods have been unsuccessful due to taste issues such as flavor, texture, and/or the like. These methods have also been unsuccessful due to an inability of the byproducts to mix with other ingredients to form food products, an inability to comply with human and/or other animal consumption safety requirements, and/or the like.

### SUMMARY

In an embodiment, a food product may include one or more portions of a dried deseeded coffee cherry and a corn-derived ingredient. The one or more portions of the dried deseeded coffee cherry may include at least one of a hull, a mucilage, a silverskin, a parchment coat, a pectin layer, a pulp, and an outer skin.

In an embodiment, a composition may include one or more portions of a dried deseeded coffee cherry and a corn-derived ingredient. The one or more portions of the dried deseeded coffee cherry may include at least one of a hull, a mucilage, a silverskin, a parchment coat, a pectin layer, a pulp, and an outer skin. The one or more portions of the dried deseeded coffee cherry have an average particle size of about 0.1 mm to about 3 mm.

In an embodiment, a method of forming a food product may include providing one or more portions of a dried deseeded coffee cherry and combining the one or more portions of the dried deseeded coffee cherry with a corn-derived ingredient to obtain a combination. The one or more portions of the dried deseeded coffee cherry may include at least one of a hull, a mucilage, a silverskin, a parchment coat, a pectin layer, a pulp, and an outer skin.

In an embodiment, a method of forming a composition may include providing a corn-derived ingredient, combining one or more portions of a dried deseeded coffee cherry with the corn-derived ingredient to obtain a combination, and grinding the combination to an average particle size of about 100 μm to about 3000 μm. The one or more portions of the dried deseeded coffee cherry may include at least one of a hull, a mucilage, a silverskin, a parchment coat, a pectin layer, a pulp, and an outer skin.

### BRIEF DESCRIPTION OF THE DRAWINGS

FIG. 1 depicts a cross sectional view of a coffee cherry structure according to an embodiment.

FIG. 2 depicts a second cross sectional view of a coffee cherry structure according to an embodiment.

FIG. 3 depicts a flow diagram of a method of forming a food product and/or a composition according to an embodiment.

FIG. 4 depicts a flow diagram of a method of preparing a corn-derived ingredient according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “coffee cherry” generally refers to one whole fruit of the coffee tree, belonging to the genus Coffea. A coffee cherry includes various portions, as described herein, including a coffee bean (or “seed”), pulp, mucilage, a hull, a stem, and the like. Species of coffee trees that produce coffee cherries include, without limitation, Coffea arabica and Coffea canephora. Beans from coffee cherries produced by the Coffea arabica tree are generally referred to as “Arabica” beans, while beans from coffee cherries produced by the Coffea canephora are generally referred to as “Robusta” beans.

A “deseeded coffee cherry” is a coffee cherry that has had the bean portion (including the center cut and the endosperm) removed. Thus, a deseeded coffee cherry contains all of the portions of the coffee cherry except for the bean and its constituent parts. Portions of the deseeded coffee cherry will be discussed in greater detail herein, and generally include hull, mucilage, silverskin, a parchment coat, a pectin layer, pulp, outer skin, a stem, leaves, and the like. In some embodiments, the deseeded coffee cherry may only include certain portions of the coffee cherry and may exclude other portions in addition to the coffee bean. In some embodiments, the deseeded coffee cherry can include the outer skin, pulp, and pectin layer.

A “composition” includes one or more portions of a dried and deseeded coffee cherry and a corn-derived ingredient, as described herein. The composition may be used, for example, as a pre-mixed composition in a food product. A “food product” is generally any edible item that is fit for consumption by humans and/or animals. In some embodiments, the food product may be a masa-based food product. The type of food product is not limited by this disclosure, and includes, for example, a baked good, a pre-fabricated good, a fried good, a chilled good, a nutritional supplement, a steamed good, a cracker, a brownie, a cake, a cake-like product, a pastry, a snack, an energy bar, a pasta, a batter coating, a batter coated item, a bread, a cookie, a noodle, a filled food product, a flatbread, a dumpling, a steamed bun, a breaded coating, a breaded item, a cereal, and/or the like. Illustrative food products may include, but are not limited to, a corn chip, a tortilla chip, a corn puff, a taco shell, hominy, pozole, and/or the like.

Components of deseeded coffee cherries possess many potentially beneficial substances if preserved in a non-degraded (non-fermented) state. For example, fresh pulp contains high levels of polyphenol antioxidants and fresh mucilage contains complex polysaccharides and antioxidants. The hull also contains small amounts of polyphenols and thus could be used as an additional source for antioxidants. Therefore, better use of these byproducts of deseeded coffee cherries could make the cultivation and processing of coffee more economical.

The food products described herein generally incorporate a corn-derived ingredient and at least a portion of the deseeded coffee cherry that would otherwise be discarded as byproduct material. Thus, the food products described herein possess beneficial properties, are generally pleasant tasting, comply with food safety requirements, and/or can be produced for mass consumption.

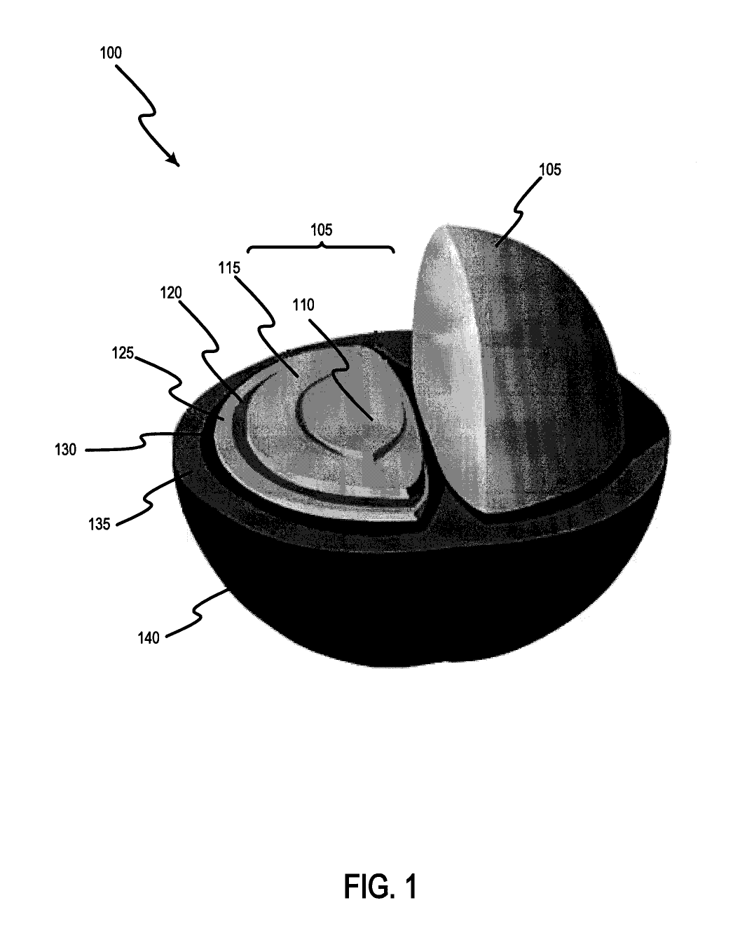

FIG. 1 depicts a cross sectional view of a coffee cherry, generally designated 100, according to an embodiment. The coffee cherry 100 generally includes the bean 105, which is the portion that is usually removed and processed for coffee beverages as described in greater detail herein. The bean 105 may generally include a center cut 110 and an endosperm 115. The center cut 110 is generally the innermost portion of the bean 105, and the endosperm 115 is generally a portion that acts as a food store because it contains a starch, protein, and other nutrients.

The remainder of the coffee cherry 100 may generally be referred to as a deseeded coffee cherry, and may contain, for example, a silverskin 120, a parchment coat 125, a pectin layer 130, a pulp 135, and an outer skin 140. In some embodiments, the deseeded coffee cherry can include the outer skin 140, pulp 135, and pectin layer 130. The silverskin 120 may also be referred to as the epidermis. The silverskin 120 is a thin tegument (covering) that is generally the innermost portion of the coffee cherry 100 that encapsulates the bean 105. The silverskin 120 is a major byproduct of the roasting process to produce roasted coffee beans, and may contain high levels of antioxidants. In general, the silverskin 120 may cling to the bean 105 even after the drying process, and may be removed via polishing or roasting the bean. When the silverskin 120 is removed from the bean 105 during the roasting process, it is typically referred to as chaff. The parchment coat 125, which may also be known as the endocarp or the hull, surrounds the silverskin 120 with a parchment-like covering. Surrounding the parchment coat 125 is the pectin layer 130, which is a mucus-like substance and may be known as the mucilage. The pectin layer 130 is surrounded by the pulp 135, which is also known as the mesocarp. The pulp 135 is a fibrous mucilagenous material that is fleshy in appearance and texture. The pulp 135 may include an amount of caffeine and tannins, thus making the pulp somewhat toxic, as described in greater detail herein. The pulp 135 may be processed to remove or reduce the level of toxins, as described in greater detail herein. The outer skin 140 is the outermost portion of the coffee cherry 100, which is generally a thick membrane that protects the various other contents of the coffee cherry. The outer skin 140 may sometimes be referred to as the exocarp. The coffee cherry 100 as used herein may also include other portions not specifically shown in FIG. 1, including a stem, leaves, and/or the like.

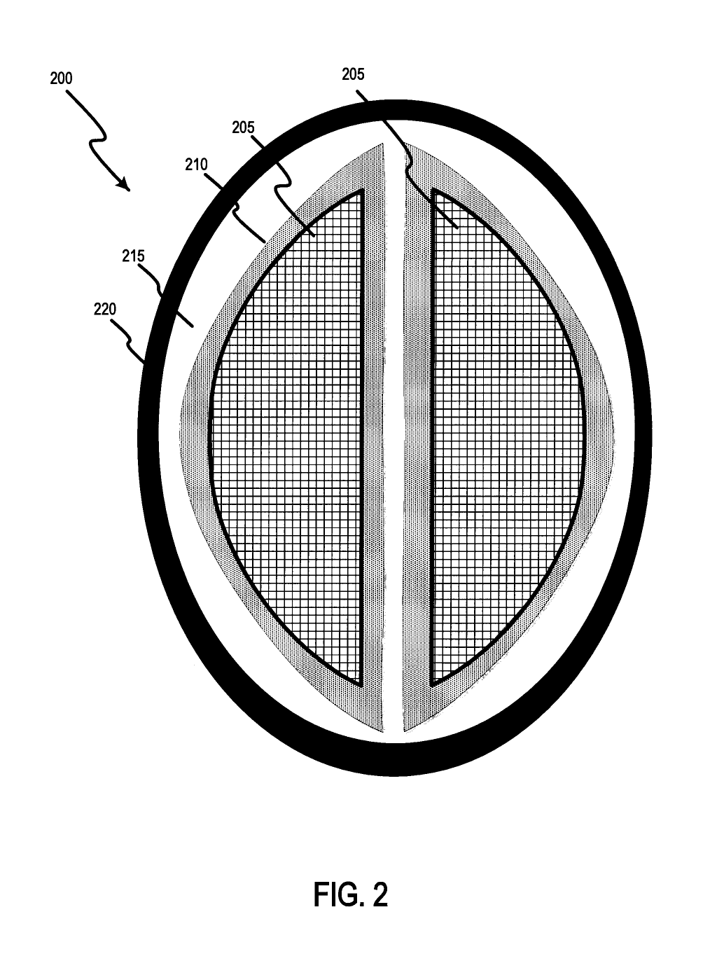

FIG. 2 depicts a second cross sectional view of a coffee cherry. As shown in FIG. 2, the coffee cherry 200 may include seeds 205 surrounded by a hull 210, a mucilage 215 and a pulp 220. The hull 210 may generally include the endocarp of the coffee cherry 200. The mucilage 215 may generally include the inner mesocarp of the coffee cherry 200. The pulp 220 may generally include at least a portion of the exocarp and the outer mesocarp of the coffee cherry 200.

In various embodiments, providing one or more of the portions of the deseeded coffee cherry may include, for example, removing a seed portion of a coffee cherry to obtain the deseeded coffee cherry. The removing of the seed portion can be performed via a wet processing or a dry processing method. In some embodiments, various portions of the deseeded coffee cherry may be dried. In particular embodiments, the deseeded portions of the coffee cherry may be dried so that they contain a moisture content (water content) of about 5% by weight to about 50% by weight, less than or equal to about 5% by weight, or greater than or equal to about 20% by weight. For example, the moisture content may be about 1% by weight, about 2% by weight, about 3% by weight, about 4% by weight, about 5% by weight, about 6% by weight, about 7% by weight, about 8% by weight, about 9% by weight, about 10% by weight, about 11% by weight, about 12% by weight, about 15% by weight, about 20% by weight, about 25% by weight, about 50% by weight, or any value or range between any two of these values (including endpoints).

Processing may further include, for example, grading and classifying the portions of the deseeded coffee cherry to remove any portions that may not be usable for the purposes described herein. Examples of grading and classifying may include, for example, removing undesirable portions, inspecting for color, inspecting for clumping, inspecting for moisture level, and/or inspecting for foreign materials.

Processing may also include grinding, milling and/or pre-milling the portions of the deseeded coffee cherry. Grinding may be performed by various grinding devices known to those having ordinary skill in the art, such as a hammer mill, a roller mill, a disk mill, or the like. The compositions and/or portions thereof may be ground to various sizes, defined by a particle size (for instance, measured in micrometers), a mesh size, a surface area, or the like. In some embodiments, the ground portions of the deseeded coffee cherry may have an average particle size of about 0.1 micrometers (μm) to about 5000 μm, about 0.1 μm to about 3000 μm, about 0.1 μm to about 200 μm, about 120 μm to about 325 μm, about 100 μm to about 500 μm, about 100 μm to about 3000 μm, or about 1000 μm to about 3000 μm. In particular embodiments, the ground portions of the deseeded coffee cherry may have an average particle size of about 0.1 μm, about 0.5 μm, about 1 μm, about 10 μm, about 25 μm, about 40 μm, about 50 μm, about 100 μm, about 200 μm, about 400 μm, about 500 μm, about 1000 μm, about 2000 μm, about 3000 μm, about 4000 μm, about 5000 μm, or any value or range between any two of these values (including endpoints). In some embodiments, the ground portions of the deseeded coffee cherry may have a coarse average particle size for shipping and transport. The coarse average particle size may be about 2000 μm to about 5000 μm, including about 2000 μm, about 2500 μm, about 3000 μm, about 4000 μm, about 5000 μm, or any value or range between any two of these values (including endpoints). In some embodiments, the ground portions of the deseeded coffee cherry may be milled at a final processing destination to produce a fine average particle size. The fine average particle size may be about 1 μm to about 400 μm, including about 1 μm, about 10 μm, about 20 μm, about 25 μm, about 40 μm, about 50 μm, about 75 μm, about 100 μm, about 200 μm, about 300 μm, about 400 μm, or any value or range between any two of these values (including endpoints). In some embodiments, the ground portions of the deseeded coffee cherry may be ground so that about 10% to about 20% of the ground portions of the deseeded coffee cherry are retained by a mesh having openings with a size of about 20 mesh and so that about 80% to about 90% of the ground portions of the deseeded coffee cherry are retained by a mesh having openings with a size of about 230 mesh. The mesh sizes may be standardized according to Table 1 below:

TABLE 1
MESH TO MICROMETER CONVERSION CHART

| U.S. MESH | INCHES | MICROMETERS |
|---|---|---|
| 3 | 0.2650 | 6730 |
| 4 | 0.1870 | 4760 |
| 5 | 0.1570 | 4000 |
| 6 | 0.1320 | 3360 |
| 7 | 0.1110 | 2830 |
| 8 | 0.0937 | 2380 |
| 10 | 0.0787 | 2000 |
| 12 | 0.0661 | 1680 |
| 14 | 0.0555 | 1410 |
| 16 | 0.0469 | 1190 |
| 18 | 0.0394 | 1000 |
| 20 | 0.0331 | 841 |
| 25 | 0.0280 | 707 |
| 30 | 0.0232 | 595 |
| 35 | 0.0197 | 500 |
| 40 | 0.0165 | 400 |
| 45 | 0.0138 | 354 |
| 50 | 0.0117 | 297 |
| 60 | 0.0098 | 250 |
| 70 | 0.0083 | 210 |
| 80 | 0.0070 | 177 |
| 100 | 0.0059 | 149 |
| 120 | 0.0049 | 125 |
| 140 | 0.0041 | 105 |
| 170 | 0.0035 | 88 |
| 200 | 0.0029 | 74 |
| 230 | 0.0024 | 63 |
| 270 | 0.0021 | 53 |
| 325 | 0.0017 | 44 |
| 400 | 0.0015 | 37 |

Thus, the portions of the deseeded coffee cherry may be ground to a particulate size that ranges from about 20 mesh to about 230 mesh, including about 20 mesh, about 25 mesh, about 30 mesh, about 35 mesh, about 40 mesh, about 45 mesh, about 50 mesh, about 60 mesh, about 70 mesh, about 80 mesh, about 100 mesh, about 120 mesh, about 140 mesh, about 170 mesh, about 200 mesh, about 230 mesh, or any value or range between two of these values (including endpoints). In some embodiments, the composition, the food product, and/or various portions thereof may have a varying distribution of particle sizes based upon the ingredients. Thus, the varying mesh sizes of each ingredient may be independent of mesh sizes for other ingredients. For example, in the food product, the one or more portions of the deseeded coffee cherry may be ground to a first distribution of particle sizes, and the corn-derived ingredient may be ground to a second distribution of particle sizes.

The deseeded coffee cherry and/or various portions thereof may naturally contain one or more toxins, including mycotoxins such as aflatoxins, fumonisins, ochratoxins, vomitoxins, and/or the like. Accordingly, processing may include reducing or removing toxins from the portions of the deseeded coffee cherry. Alternatively, processing may include removing or reducing toxins from the composition. The reducing or removing of toxins may improve consumers' safety and/or to comply with various safety regulations such as, for example, the World Health Organization's (WHO) International Programme on Chemical Safety (IPCS) or the Scientific Committee on Food (SCF) of the European Union (EU). Thus, in some embodiments, the portions of the deseeded coffee cherry and/or the composition may have an aflatoxin mycotoxin level of equal to or less than about 20 parts per billion (ppb) for total aflatoxins, a fumonisin mycotoxin level of equal to or less than about 2 micrograms (μg) per kilogram of body weight of a consumer for total fumonisins, an ochratoxin mycotoxin level of equal to or less than about 10 ppb for total ochratoxins, and/or a vomitoxin mycotoxin level of equal to or less than about 1 part per million (ppm) for total vomitoxins. In particular embodiments, the portions of the deseeded coffee cherry and/or the composition may have an aflatoxin mycotoxin level of about 20 ppb, about 15 ppb, about 10 ppb, about 5 ppb, about 1 ppb, about 0.5 ppb, about 0.1 ppb, about 0.05 ppb, about 0 ppb, or any value or range between any two of these values (including endpoints). In particular embodiments, the portions of the deseeded coffee cherry and/or the composition may have a fumonisin mycotoxin level of, per kilogram of body weight of a consumer, about 2 μg, about 1 μg, about 0.5 μg, about 0.1 μg, about 0.05 μg, about 0 μg, or any value or range between any two of these values (including endpoints). In some embodiments, the portions of the deseeded coffee cherry and/or the composition may have a fumonisin mycotoxin level of about 2 ppm to about 5 ppm, such as, for example, about 2 ppm, about 3 ppm, about 4 ppm, about 5 ppm, or any value or range between any two of these values (including endpoints). In particular embodiments, the portions of the deseeded coffee cherry and/or the composition may have an ochratoxin mycotoxin level of about 10 ppb, about 5 ppb, about 1 ppb, about 0.5 ppb, about 0.1 ppb, about 0.5 ppb, or any value or range between any two of these values (including endpoints). In particular embodiments, the portions of the deseeded coffee cherry, the food product, and/or the composition may have a vomitoxin mycotoxin level of about 1 ppm, about 0.5 ppm, about 0.1 ppm, about 0.05 ppm, about 0.01 ppm, or any value or range between any two of these values (including endpoints).

In various embodiments, the one or more portions of the deseeded coffee cherry may have a peak viscosity as measured by heating a paste at 90° C. in a Rapid Visco Analyzer. The paste may be formed from the one or more portions of the deseeded coffee cherry prepared in a slurry containing 5.5% composition by dry weight. Alternatively, peak viscosity can be measured with the product at ambient room temperature in dry form without forming a slurry. The peak viscosity may be about 30 rapid visco units to about 3000 rapid visco units or about 200 rapid visco units to about 500 rapid visco units. For example, the peak viscosity may be about 30 rapid visco units, about 50 rapid visco units, about 100 rapid visco units, about 200 rapid visco units, about 500 rapid visco units, about 1000 rapid visco units, about 2000 rapid visco units, about 3000 rapid visco units, or any value or range between any two of these values (including endpoints).

In various embodiments, the one or more portions of the deseeded coffee cherry may absorb water. The amount of water absorbed by the one or more portions of the deseeded coffee cherry may be measured, for example, by placing a measured amount by weight of the one or more portions of the deseeded coffee cherry in a container with a measured amount of water, and then incubating and stirring the mixture. Excess water is drained from the mixture and the moist precipitate is weighed. A water absorption index (WAI) can be calculated with the following equation:

$$WAI = \frac{mass of moist precipitate}{mass of composition}$$

In some embodiments, the one or more portions of the deseeded coffee cherry may have a water absorption index of about 1 to about 20, including about 1, about 2, about 5, about 10, about 15, about 20, or any value or range between any two of these values (including endpoints).

In various embodiments, a food product and/or a composition may include one or more portions of the dried deseeded coffee cherry and a corn-derived ingredient, as described in greater detail herein. In some embodiments, the one or more portions of the dried deseeded coffee cherry may be about 5% to about 50% by weight of the food product. For example, the one or more portions of the dried deseeded coffee cherry may by about 5% by weight, about 10% by weight, about 15% by weight, about 20% by weight, about 25% by weight, about 30% by weight, about 35% by weight, about 40% by weight, about 45% by weight, about 50% by weight, or any value or range between any two of these values (including endpoints).

In some embodiments, the food product and/or the composition may have a water content. The water content may be equal to or greater than about 20% by weight or less than or equal to about 5% by weight. For example, the water content may be about 20% by weight, about 25% by weight, about 30% by weight, about 35% by weight, about 40% by weight, about 45% by weight, about 50% by weight, or any value or range between any two of these values (including endpoints). In another example, the water content may be about 1% by weight, about 2% by weight, about 3% by weight, about 4% by weight, about 5% by weight, or any value or range between any two of these values (including endpoints).

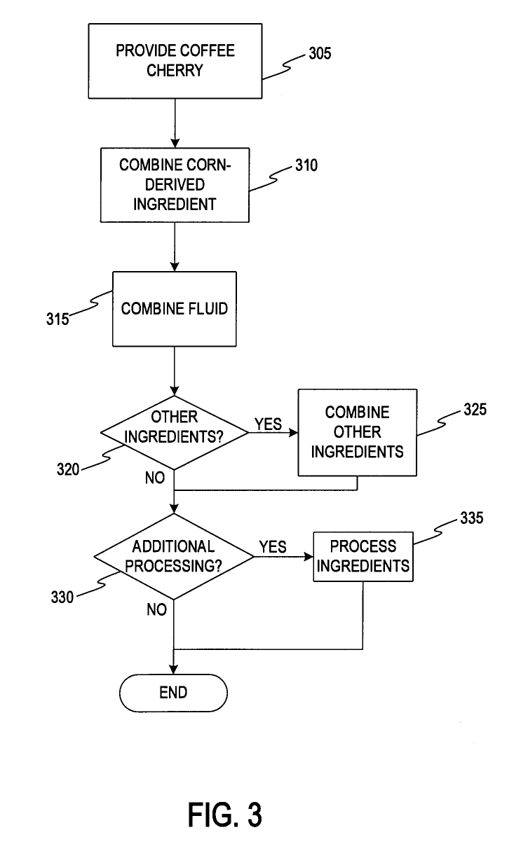

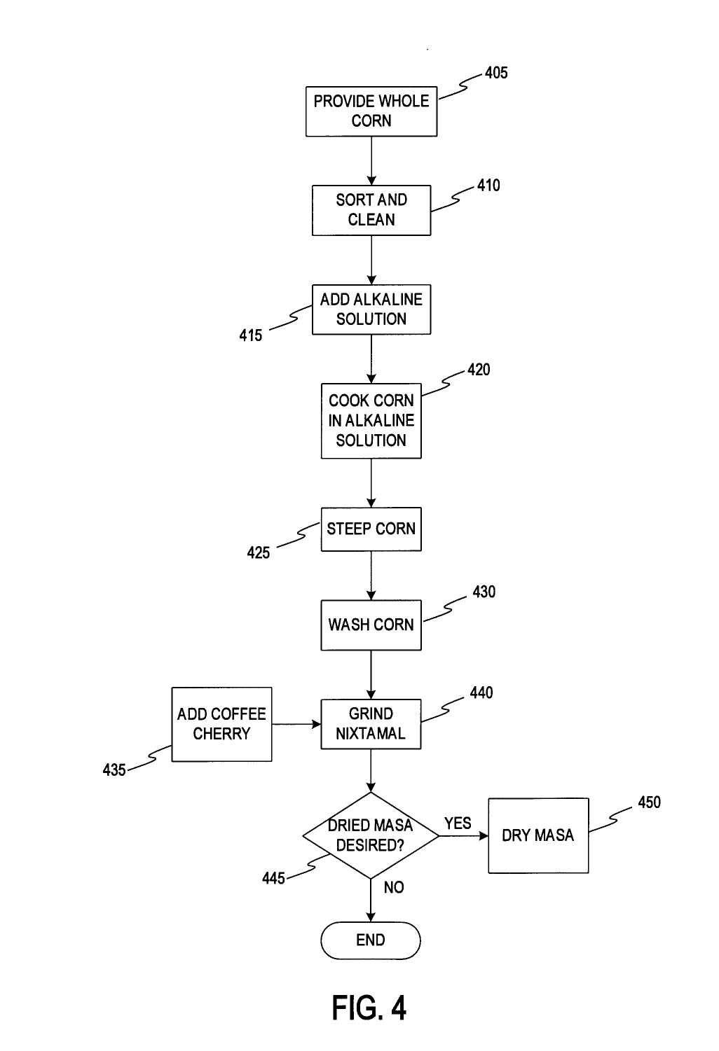

The food product and the composition may each be formed via similar methods. Accordingly, the method described with respect to FIGS. 3 and 4 may be used to form the food product and/or the composition. FIG. 3 depicts a flow diagram of a method of forming a food product and/or a composition according to an embodiment. The method described in reference to FIG. 3 may generally be used in whole or in part to form an edible food product. In some embodiments, one or more portions of a dried deseeded coffee cherry may be provided 305. The amount of the one or more portions of the dried deseeded coffee cherry to be provided 305 may be based upon an amount necessary to obtain a desired food product, a desired composition, a desired taste, a desired texture, a desired consistency, and/or the like. In some embodiments, the one or more portions of the dried deseeded coffee cherry may be present in the food product and/or the composition in an amount of about 1% to about 80% by weight of the food product. In particular embodiments, the one or more portions of the deseeded coffee cherry may be present in the food product and/or the composition in an amount of about 1% by weight, about 2% by weight, about 5% by weight, about 10% by weight, about 15% by weight, about 20% by weight, about 25% by weight, about 35% by weight, about 40% by weight, about 50% by weight, about 75% by weight, about 80% by weight, or any value or range between any two of these values (including endpoints).

In various embodiments, a corn-derived ingredient may be combined 310 with the one or more portions of the coffee cherry to obtain a combination. Combining 310 the one or more portions of the coffee cherry and the corn-derived ingredient can be completed by any method of combining, including, but not limited to, hand mixing, mixing with an electric handheld mixer, mixing with a stand mixer, mixing with a commercial mixing device, and/or the like. In some embodiments, the combining 310 may be completed for a particular period of time, according to a particular method, and/or at a particular speed such that the combination is sufficiently blended. The combination may be sufficiently blended if a random sample of the combination contains a ratio of an amount by weight of the one or more portions of the coffee cherry to an amount by weight of the corn-derived ingredient that corresponds to a desired ratio according to a particular recipe. For example, the ratio of the amount by weight of the one or more portions of the coffee cherry to the amount by weight of the corn-derived ingredient may be about 1:1, about 2:1, about 3:1, about 5:1, about 10:1, about 20:1, about 1:2, about 1:3, about 1:5, about 1:10, about 1:20, or any value or range between any of these values.

The corn-derived ingredient may generally be any ingredient that is derived from corn, and is not limited by this disclosure. In some embodiments, the corn-derived ingredient may be derived from dried kernel maize and/or corn. In some embodiments, the corn-derived ingredient may be corn that is treated via a nixtamalization process, as shown in FIG. 4. In some embodiments, the treatment may result in a corn-derived ingredient with an increased nutritional value, an enhanced flavor, an enhanced aroma, and/or a reduction of mycotoxins, as described in greater detail herein.

As shown in FIG. 4, treatment may generally include providing 405 whole corn kernels and sorting and/or cleaning 410 the corn. Sorting and/or cleaning 410 may be completed such that any poor quality kernels are removed and/or such that that various contaminants are removed from the corn. Sorting and/or cleaning 410 may include sorting and/or cleaning via screening and/or using a dust collection system.

An alkaline solution may be added 415 to the corn kernels. The alkaline solution is not limited by this disclosure and may include, for example, lime (calcium hydroxide) and/or ash, such as limewater and/or the like. The corn may be cooked 420 in the alkaline solution, which may include, for example, heating the alkaline solution to a boiling point. The corn may be steeped 425 for a period of time before, during, and/or after cooking 420. Cooking 420 and/or steeping 425 may increase a moisture content of the corn kernels and/or may loosen or separate the corn kernels from the hull of the corn. The corn may be washed 430 to remove the hull and/or surface film from the corn to obtain a nixtamal. Washing 430 may include sieving the corn.

The nixtamal may be ground 440 to obtain a masa composition. In some embodiments, grinding 440 may include adding 435 the one or more portions of the coffee cherry and grinding the combination of nixtamal and coffee cherry portions. Thus, grinding 440 may be a portion of the process of combining 310 (FIG. 3) the corn-derived ingredient with the one or more portions of the coffee cherry, as described herein. Grinding 440 may include grinding to a particle size distribution, as described in greater detail herein. Grinding 440 may also include use of any device or apparatus to achieve grinding, such as a mill or the like, as described in greater detail herein. A determination 445 may be made as to whether a dry masa composition or a wet composition is desired. If a dry composition, such as a flour or the like is desired, the masa and/or the one or more portions of the coffee cherry may be dried 450. If a wet composition is desired, no other process may be necessary. Alternatively, additional fluid may be added, such as the fluid described with respect to process 315 (FIG. 3).

Referring back to FIG. 3, at least one fluid may be combined 315 with the combination to obtain a mixture. In some embodiments, the mixture may be a dough. In some embodiments, the fluid may be used to disperse at least one of the other ingredients described herein. In some embodiments, the fluid may be used to dissolve at least one of the other ingredients described herein. In some embodiments, the amount of fluid present in the mixture may be about 20% by weight to about 70% by weight of the mixture or about 20% by weight to about 50% by weight of the mixture. For example, the amount of fluid present may include about 20% by weight, about 25% by weight, about 30% by weight, about 35% by weight, about 40% by weight, about 45% by weight, about 50% by weight, about 55% by weight, about 60% by weight, about 65% by weight, about 70% by weight, or any value or range between any two of these values (including endpoints). Correspondingly, the amount of the combination present in the mixture may be about 30% by weight to about 80% by weight of the mixture or about 50% by weight to about 80% by weight of the mixture. For example, the amount of the combination present may include about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values (including endpoints). The type of fluid is not limited by this disclosure, and may include any fluid, liquid, semiliquid, slurry, and/or the like, including fluid versions of other ingredients described herein, water, juice, broth, maltodextrin solids, corn syrup solids, and/or the like. Other fluids include dairy milk, non-dairy milk, nut milks, rice milks, tea, coffee, kava, and other dried food extract fluids, and so on.

In various embodiments, a determination 320 may be made as to whether additional ingredients should be added to the mixture. The determination 320 may generally be based upon, for example, a desired type of food product, a desired flavor, a desired texture, a desired consistency, whether additional nutrients are needed, and/or the like.

If the determination 320 is that additional ingredients should be added, the additional ingredients may be combined 325 with the mixture. The additional ingredients may be provided in addition to the fluid, or in some embodiments, may be a portion of the fluid. Examples of additional ingredients are not limited by this disclosure, and may include, for example, flour, a black bean, a flax seed, a sesame seed, a sunflower seed, a fat, a dairy product, a starch, a gum, a reducing sugar, a flavoring agent, a leavening agent, an enzyme, an egg, an egg white, an egg yolk, and/or the like.

The flour may generally be any type of flour composition now known or later developed, particularly flour compositions suitable for consumption purposes. The flour may be made from cereal grains, seeds, beans, nuts, roots, and/or the like. Specific examples of flour may include soy flour, tapioca flour, rice flour, oat flour, wheat flour, buckwheat flour, barley flour, rye flour, corn flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, and the like, as well as mixtures thereof. In some embodiments, the flour, and by extension, the mixture, may be substantially gluten free, thereby containing a gluten content of equal to or less than about 20 parts per million (ppm), including about 20 ppm, about 15 ppm, about 10 ppm, about 5 ppm, about 1 ppm, about 0.5 ppm, about 0.1 ppm, about 0.05 ppm, or any value or range between any two of these values (including endpoints).

A fat may be combined 325 to provide a desired texture and/or consistency, to add flavor, to provide a moist food product, and/or to act as a binder for the remaining ingredients in the food product. Specific examples of fats may include oil, butter, margarine, shortening, lard, and/or the like. Illustrative oils may include vegetable oil, castor oil, egg oil, rapeseed oil, soybean oil, corn oil, coconut oil, palm oil, safflower oil, sunflower seed oil, cottonseed oil, sesame oil, olive oil, camellia oil, rice oil, and/or the like.

In some embodiments, dairy products may be added to provide a desired texture and/or consistency, to add flavor, to provide a moist food product, and/or to act as a binder for the remaining ingredients in the food product. Specific examples of dairy products may include butter, cheese, milk, buttermilk, condensed milk, powdered milk, whey, yogurt, cream, whipping cream, sour cream, and/or the like.

The starch may be used as a thickening and/or a stabilizing agent. Specific examples of starches may include starch hydrolysate, hydroxyalkylated starch, starch ester, cross-linked starch, starch acetate, starch octenyl succinate, and/or the like.

The gum may be combined 325 to provide a desired texture and/or consistency, to thicken the food product, and/or to stabilize the food product. Specific examples of gums may include guar gum, xanthan gum, gellan gum, carrageenan gum, gum Arabic, gum tragacanth, pectic acid, and/or the like. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods.

The reducing sugar may be used to provide a desired texture, consistency, and/or color properties to the food product. The reducing sugar may generally be any sugar that has an aldehyde group or any sugar that is capable of forming an aldehyde group via isomerism. Specific examples of reducing sugars may include maltose, lactose, dextrose and/or the like.

The flavoring agent is not limited by this disclosure, and may generally be any ingredient used to provide a flavor to the mixture. In some embodiments, the flavoring agent may be a sweetener. The sweetener may be in a solid, a semi-solid, or a liquid form, and may further be a caloric or a noncaloric sweetener. Specific examples of caloric sweeteners may include glucose, dextrose, fructose, lactose, sucrose, isomaltose, maltodextrin, corn syrup, and the like, as well as mixtures thereof. Specific examples of noncaloric sweeteners may include acesulfame potassium, aspartame, neotame, saccharin, sucralose, and the like, as well as mixtures thereof. In some embodiments, the flavoring agent may provide a savory flavor. Such a flavoring agent may include, for example, barbecue, bacon, spices, herbs, dry vegetables such as onion, garlic, or tomato, dairy, peanut butter, nuts, seeds, vanilla, chocolate, and/or the like. In some embodiments, the flavoring agent may be blended with or sprinkled on any of the ingredients or compositions described herein. In some embodiments, the flavoring agent may be used as a topping or a sandwich filling in addition to any of the ingredients or compositions described herein.

The leavening agent may be added to provide a desired texture and/or consistency, to lighten the food product, and/or to soften the food product. Specific examples of leavening agents may include a carbon dioxide (CO₂) carrier agent such as baking soda, tartaric acid, citric acid, acid sodium, potassium salts of tartaric acid, calcium salts of tartaric acid, potassium salts of citric acid, calcium salts of citric acid, orthophosphoric acid, pyrophosphoric acid, calcium lactate, calcium sulfate, and/or the like.

The enzyme may aid in processing various starches used in the food product. In some embodiments, the enzyme may improve the quality of the food product so that it conforms to a desired taste and/or consistency. Specific examples of enzymes may include papain, bromelain, ficin, trypsin, chymotrypsin, and/or the like.

In some embodiments, the additional ingredients may include an emulsifier. The emulsifier may aid in the processability of the food product. In some embodiments, the emulsifier may be dissolved in a fat or in a polyol fatty acid polyester. An illustrative polyol fatty acid polyester is Olean™ (Proctor & Gamble, Cincinnati Ohio). Illustrative emulsifiers may include, for example, lecithin, monoglycerides, diglycerides, diacetyl tartaric acid esters, propylene glycol monoesters, propylene glycol diesters, polyglycerol esters and/or the like. Polyglycerol emulsifiers, such as monoesters of hexapolyglycerols, may also be used.

In various embodiments, the various ingredients described herein may be added to the mixture and/or the composition in the form of a pre-blended material. The pre-blended material is not limited by this disclosure and may include any type of pre-blended material, such as pre-packaged items and the like. For example, the various ingredients may be combined to the composition in the form of a boxed cake mix, a boxed brownie mix, a boxed bread mix, and/or the like.

In various embodiments, a determination 330 may be made as to whether additional processing of the ingredients is necessary. If additional processing is necessary, the ingredients may be processed 335. Examples of additional processing may include, for example, sheeting, extruding, cutting, filing, folding, baking, boiling, frying, freezing, steaming, packaging and/or the like. The additional processing may generally be completed to cook the ingredients to obtain the food product, to convert the ingredients into the food product, to prepare the ingredients for shipping and delivery, and/or the like.

In some embodiments, the processing 335 may include forming a dough into a relatively flat, thin sheet. This may be completed by any method now known or later developed, including rolling the dough between two counter rotating cylindrical rollers to obtain a uniform, relatively thin sheet of dough material. In addition, any conventional sheeting, milling, and gauging equipment may be used. In some embodiments, each of two mill rolls may be used at a temperature of about 90° F. (32.2° C.) to about 135° F. (57.2° C.), including about 90° F. (32.2° C.), about 95° F. (32.2° C.), about 100° F. (37.8° C.), about 105° F. (40.6° C.), about 110° F. (43.3° C.), about 115° F. (46.1° C.), about 120° F. (48.9° C.), about 125° F. (51.7° C.), about 130° F. (54.4° C.), about 135° F. (57.2° C.), or any value or range between any two of these values (including endpoints). In some embodiments, each mill roll may have a temperature that is independent of the temperature of the other mill roll. Thus, for example, a first mill roll may be hotter than a second mill roll. In some embodiments, the sheet of dough may have an average thickness of about 0.013 cm to about 0.25 cm, about 0.038 cm to about 0.25 cm, or about 0.165 cm to about 0.203 cm, including about 0.013 cm, about 0.015 cm, about 0.025 cm, about 0.05 cm, about 0.1 cm, about 0.15 cm, about 0.165 cm, about 0.2 cm, about 0.203 cm, about 0.25 cm, or any range or value between any two of these values (including endpoints). In some embodiments, the dough may be formed by using any stamping and/or cutting equipment to form a sheet of dough into a plurality of predetermined shapes and sizes. Illustrative examples of shapes may include ovals, squares, bowtie-shaped, star-shaped, wheel-shaped, and pinwheel-shaped. In some embodiments, the dough may be scored to form ripples.

In various embodiments, the ingredients may be processed 335 via frying. In some embodiments, the ingredients may be coated with a coating, such as a batter coating and/or the like before frying. In other embodiments, a food product may be coated with the ingredients before frying. In some embodiments, the ingredients may be fried in a fat composition comprising a digestible fat, a non-digestible fat, or mixtures thereof. In some embodiments, the fat composition may have a free fatty acid content of about 1% or less by weight to reduce the oil oxidation rate. In particular embodiments, the fat composition may have a free fatty acid content of about 1% by weight, about 0.5% by weight, about 0.3% by weight, about 0.25% by weight, about 1% by weight, about 0.05% by weight, 0% by weight, or any range or value between any two of these values (including endpoints).

In some embodiments, the fat composition may have a saturated fat content of about 25% or less by weight to improve the lubricity of the ingredients fried in the fat composition and to enhance the flavor profile of the ingredients because of a lower melting point of the oil. In particular embodiments, the fat composition may have a saturated fat content of about 25% by weight, about 20% by weight, about 15% by weight, about 10% by weight, about 5% by weight, about 1% by weight, 0% by weight, or any value or range between any two of these values (including endpoints). An illustrative example of a saturated fat may include a sunflower oil, particularly a sunflower oil containing a medium to a high level of oleic acid. A medium to a high level of oleic acid may be defined as sunflower oil having at least about 60% by weight of oleic acid, including about 60%, about 65% by weight, about 70%, about 75% by weight, about 80%, about 85% by weight, about 90%, about 95% by weight, about 100% by weight, or any value or range between any two of these values (including endpoints).

In some embodiments, the non-digestible fat may be present in an amount of about 10% by weight to about 90% by weight, about 50% by weight to about 90% by weight, about 70% by weight to about 85% by weight, including about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, about 85% by weight, about 90% by weight, or any value or range between any two of these values (including endpoints). In some embodiments, the digestible fat may be present in an amount of about 10% by weight to about 80% by weight, about 10% by weight to 50% by weight, about 15% by weight to about 30% by weight, including about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, or any value or range between any two of these values (including endpoints). In some embodiments, the fat composition may include at least one other ingredient such as, for example, an antioxidant such as tert-butylhydroquinone (TBHQ), tocopherols, and ascorbic acid; a chelating agent such as citric acid; or an anti-foaming agent such as dimethylpolysiloxane.

In various embodiments, the ingredients may be fried in the fat composition when it is heated to a temperature of about 275° F. (135° C.) to about 420° F. (215.6° C.), about 300° F. (148.9° C.) to about 410° F. (210° C.), about 350° F. (176.7° C.) to about 400° F. (204.4° C.), including about 275° F. (135° C.), about 300° F. (148.9° C.), about 325° F. (162.8° C.), about 350° F. (176.7° C.), about 375° F. (190.6° C.), about 400° F. (204.4° C.), about 410° F. (210° C.), about 420° F. (215.6° C.), or any range or value between any two of these values (including endpoints).

The ingredients may be fried in the fat composition for a period of time that is sufficient to result in a food product having about 6% or less by weight moisture, including about 6% by weight, about 5% by weight, about 4% by weight, about 2.5% by weight, about 2% by weight, about 1% by weight, about 0.5% by weight, or any value or range between any two of these values (including endpoints). Those with ordinary skill in the art will recognize varying frying times and moisture contents that may be suitable based on the types of ingredients included in the composition.

In some embodiments, the ingredients may be fried using a continuous frying method where the ingredients are passed into the fat composition until they are cooked, whereupon they are removed. In some embodiments, the ingredients may be fried using a continuous frying or batch frying method where the ingredients are immersed in a frying fat composition on a moving belt or basket.

The resultant food product from processing 335 by frying may have a total fat content (including digestible and non-digestible fats) of about 25% by weight to about 40% by weight, including about 25% by weight, about 30% by weight, about 35% by weight, about 40% by weight, or any value or range between any two of these values (including endpoints). In some embodiments, a higher fat content may be desired. Accordingly, an oil (such as a triglyceride oil) may be applied to the ingredients as they are removed from the fat composition. In some embodiments, the triglyceride oil may have an iodine adsorption value greater than about 75 or greater than about 90, including about 75, about 80, about 85, about 90, about 95, about 100, about 150, about 200, about 204, or any value or range between any two of these values (including endpoints). The iodine adsorption value is a term generally recognized in the art as being the mass of iodine (in grams) that is consumed by 100 grams of the oil. The additional applied oil may raise the fat content of the ingredients to about 45% by weight, including about 25% by weight, about 30% by weight, about 35% by weight, about 40% by weight, about 45% by weight, or any value or range between any two of these values (including endpoints).

In some embodiments, various oils having characteristic flavors may be applied to the ingredients. The various oils may be applied via spraying, tumbling, or any other method of application. Illustrative examples of the various oils may include butter flavored oils, natural flavored oils, artificially flavored oils, herb oils, potato flavored oils, garlic flavored oils, and onion flavored oils. In some embodiments, the application of the various oils after frying may avoid browning, burning, and/or oxidation of the various oils during the frying process, which may detract from taste, color, consistency, and/or the like.

In various embodiments, the ingredients described herein may be coated on a food product. For example, the ingredients may provide a batter coating. In some embodiments, the food product with the coated ingredients may be fried.

### EXAMPLES

### Example 1

### Making Corn Tortillas

A tortilla is a type of thin, unleavened flatbread made from finely ground corn that is a staple of Mexican and Central American cuisine. Corn tortillas are sold all over the world and are readily available in pre-packaged formats. A typical recipe for corn tortillas incorporates masa harina. However, in the present recipe, masa harina will be substituted with a composition having 50% by weight dried deseeded coffee cherries and 50% by weight masa. The composition will be ground to an average particle size of about 25 μm. Two cups of the composition will be mixed with 2 cups of water and ¼ teaspoon of baking soda until the resulting mixture is well blended. A typical recipe will be followed, which includes allowing the mixture to stand for 5 minutes, kneading the mixture to form a dough, and pressing portions of the dough in a tortilla press. The pressed dough will be placed on a hot griddle for 30 seconds on each size to form the resulting tortilla.

The result will be a tortilla having a dark brown chocolate appearance, a sponge-like texture, and a citrus-cherry-corn flavor. Due to the high antioxidant content of the deseeded coffee cherries, the tortillas are also expected to contain a high level of antioxidants. Accordingly, the deseeded coffee cherries that were traditionally considered waste by coffee producers will be formed into food products.

### Example 2

### Making Tortilla Chips

Tortilla chips will be made from the dough made in accordance with Example 1. The dough will be shaped into a cylindrical roll and will be cut into slices of 3 mm thick each. The slices of tortilla chips will be placed into a deep fryer having canola oil heated to about 175° C., and will be fried for about 2 minutes, or until crispy. The tortilla chips will be removed from the oil and allowed to dry. Sea salt will be sprinkled over the chips.

The resulting tortilla chips will have a medium brown appearance, a crispy texture, and a citrus-cherry-corn flavor. Due to the high antioxidant content of the deseeded coffee cherries, the tortilla chips are also expected to contain a high level of antioxidants. Accordingly, the deseeded coffee cherries that were traditionally considered waste by coffee producer will be formed into food products.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A food product comprising:
one or more portions of a dried deseeded coffee cherry; and
a corn-derived ingredient.

2. The food product of claim 1, wherein the one or more portions of the dried deseeded coffee cherry comprises at least one of a hull, a mucilage, a silverskin, a parchment coat, a pectin layer, a pulp, and an outer skin.

3. The food product of claim 1, wherein the one or more portions of the dried deseeded coffee cherry do not comprise a coffee bean.

4. The food product of claim 1, wherein the food product is a masa-based food product.

5. The food product of claim 1, wherein the corn-derived ingredient is at least one of:
corn treated with an alkaline solution;
nixtamalized corn kernels; and
derived from at least one of dried kernel maize and corn.

6.-7. (canceled)

8. The food product of claim 1, wherein the one or more portions of the dried deseeded coffee cherry have at least one of:
an average particle size of about 0.1 μm to about 3000 μm; and
a peak viscosity of about 30 rapid visco units to about 3000 rapid visco units.

9.-10. (canceled)

11. The food product of claim 1, wherein the food product has a water content of:
less than or equal to about 5% by weight of the food product; or
greater than or equal to about 20% by weight of the food product.

12. (canceled)

13. The food product of claim 1, wherein the one or more portions of the dried deseeded coffee cherry comprise about 5% to about 50% by weight of the food product.

14.-15. (canceled)

16. The food product of claim 1, further comprising at least one of:
a fluid, wherein the fluid is present in the food product in an amount of about 20% by weight to about 50% by weight of the food product; and
a flour composition made from at least one of cereal grains, seeds, nuts, beans, and roots.

17.-18. (canceled)

19. The food product of claim 1, further comprising at least one of soy flour, tapioca flour, rice flour, oat flour, wheat flour, buckwheat flour, barley flour, rye flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, black beans, flax seeds, sesame seeds, sunflower seeds, oil, butter, margarine, shortening, lard, starch hydrolyzate, hydroxyalkylated starch, starch ester, cross-linked starch, starch acetate, starch octenyl succinate, guar gum, xanthan gum, gellan gum, carrageenan gum, gum Arabic, gum tragacanth, pectic acid, maltose, lactose, dextrose, glucose, fructose, lactose, sucrose, isomaltose, maltodextrin, and corn syrup.

20.-25. (canceled)

26. The food product of claim 1, wherein the food product is at least one of a baked good, a pre-fabricated good, a fried good, a chilled good, a nutritional supplement, a steamed good, a corn chip, a tortilla chip, a corn puff, a taco shell, hominy, pozole, a cracker, a brownie, a cake, a cake-like product, a pastry, a snack, an energy bar, a batter coating, a cookie, a bread, a pasta, a noodle, a filled food product, a flatbread, a dumpling, a steamed bun, a breaded coating, and a cereal.

27.-28. (canceled)

29. The food product of claim 1, wherein the one or more portions of the dried deseeded coffee cherry have mycotoxin levels of less than about 20 parts per billion for total aflatoxins, less than about 2 parts per million for total fumonisins, less than about 10 parts per billion for total ochratoxins, and less than about 5 parts per million for total vomitoxins.

30.-33. (canceled)

34. The food product of claim 1, wherein the food product has a gluten content of less than about 20 parts per million.

35. A composition comprising:
one or more portions of a dried deseeded coffee cherry, wherein the one or more portions of the dried coffee cherry have an average particle size of about 0.1 μm to about 3000 μm; and
a corn-derived ingredient.

36. The composition of claim 35, wherein the one or more portions of the dried deseeded coffee cherry comprises at least one of a hull, a mucilage, a silverskin, a parchment coat, a pectin layer, a pulp, and an outer skin.

37. The composition of claim 35, wherein the one or more portions of the dried coffee cherry do not comprise a coffee bean.

38. The composition of claim 35, wherein the composition is a masa composition.

39. The composition of claim 35, wherein the corn-derived ingredient is at least one of:
corn treated with an alkaline solution;
nixtamalized corn kernels; and
derived from at least one of dried kernel maize and corn

40.-41. (canceled)

42. The composition of claim 35, wherein the one or more portions of the dried deseeded coffee cherry have at least one of:
an average particle size of about 0.1 μm to about 3000 μm; and
a peak viscosity of about 30 rapid visco units to about 3000 rapid visco units.

43. (canceled)

44. The composition of claim 35, wherein the composition has a water content of:
less than or equal to about 5% by weight of the food product; or
greater than or equal to about 20% by weight of the food product.

45.-47. (canceled)

48. The composition of claim 35, further comprising a flour composition made from at least one of cereal grains, seeds, nuts, beans, and roots.

49. The composition of claim 35, further comprising at least one of soy flour, tapioca flour, rice flour, oat flour, wheat flour, buckwheat flour, barley flour, rye flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, black beans, flax seeds, sesame seeds, sunflower seeds, oil, butter, margarine, shortening, lard, starch hydrolyzate, hydroxyalkylated starch, starch ester, cross-linked starch, starch acetate, starch octenyl succinate, guar gum, xanthan gum, gellan gum, carrageenan gum, gum Arabic, gum tragacanth, pectic acid, maltose, lactose, dextrose, glucose, fructose, lactose, sucrose, isomaltose, maltodextrin, and corn syrup.

50. (canceled)

51. The composition of claim 35, wherein the one or more portions of the dried deseeded coffee cherry have mycotoxin levels of less than about 20 parts per billion for total aflatoxins, less than about 2 parts per million for total fumonisins, less than about 10 parts per billion for total ochratoxins, and less than about 5 parts per million for total vomitoxins.

52.-55. (canceled)

56. A method of forming a food product, the method comprising:
removing at least one coffee bean from a coffee cherry to obtain one or more portions of a deseeded coffee cherry;
subsequent to removing, drying the one or more portions of the deseeded coffee cherry to obtain one or more portions of a dried deseeded coffee cherry; and
combining the one or more portions of the dried deseeded coffee cherry with a corn-derived ingredient to obtain a combination.

57.-58. (canceled)

59. The method of claim 56, further comprising combining at least one fluid with the combination to obtain a dough.

60. The method of claim 59, further comprising at least one of:
processing the dough to obtain a dough product, wherein the processing comprises one or more of sheeting, extruding, cutting, filing, and folding;
baking the dough;
frying the dough;
freezing the dough;
steaming the dough; and
coating a food item with the dough to form a coated food.

61.-65. (canceled)

66. The method of claim 56, further comprising combining the combination with one or more of an oil, a fat, soy flour, tapioca flour, rice flour, oat flour, wheat flour, buckwheat flour, barley flour, rye flour, bean flour, peanut flour, almond flour, chestnut flour, acorn flour, amaranth flour, hemp flour, sorghum flour, sweet potato flour, chickpea flour, quinoa flour, taro flour, arrowroot flour, coconut flour, potato flour, at least one dairy product, at least one flavoring agent, at least one leavening agent, and at least one enzyme.

67.-71. (canceled)

72. The method of claim 56, further comprising combining at least one of the following with the combination:
at least one sweetener, wherein the sweetener comprises glucose, fructose, lactose, sucrose, isomaltose, maltodextrin, or corn syrup;
at least one modified starch, wherein the modified starch comprises starch hydrolyzate, hydroxyalkylated starch, starch ester, cross-linked starch, starch acetate, or starch octenyl succinate;
at least one gum, wherein the gum comprises guar gum, xanthan gum, gellan gum, carrageenan gum, gum Arabic, gum tragacanth, or pectic acid; and
at least one reducing sugar, wherein the reducing sugar comprises one or more of maltose, lactose, or dextrose.

73.-75. (canceled)

76. A method of forming a composition, the method comprising:
removing at least one coffee bean from a coffee cherry to obtain one or more portions of a deseeded coffee cherry;
subsequent to removing, drying the one or more portions of the deseeded coffee cherry to obtain one or more portions of a dried deseeded coffee cherry;
combining the one or more portions of the dried deseeded coffee cherry with a corn-derived ingredient to obtain a combination; and
grinding the combination to an average particle size of about 0.1 μm to about 3000 μm.

77.-78. (canceled)

79. The method of claim 76, wherein providing a corn-derived ingredient comprises:
providing whole kernel corn, wherein the whole kernel corn comprises at least one of dried kernel maize and corn;
sorting the whole kernel corn to obtain sorted corn;
cleaning the sorted corn to obtain cleaned corn;
cooking the cleaned corn in an alkaline solution to obtain cooked corn;
soaking the cooked corn; and
removing a hull and a surface film from the cooked corn to obtain the corn-derived ingredient.

80. The method of claim 76, wherein the alkaline solution is limewater.

81.-82. (canceled)

83. The food product of claim 1, wherein a coffee bean has been removed from the coffee cherry prior to a drying process.

84. The composition of claim 35, wherein a coffee bean has been removed from the coffee cherry prior to a drying process.
